(19) United States
(12) Patent Application Publication
(10) Pub. No.: US 2016/0356941 A1
(43) Pub. Date: Dec. 8, 2016

(54) LIGHT SOURCE UNIT AND METHOD FOR MANUFACTURING THE SAME

(71) Applicant: GOODLED CO., LTD, Incheon (KR)

(72) Inventors: Jae Chul JU, Incheon (KR); Yeong Seok KIM, Incheon (KR)

(21) Appl. No.: 14/948,243

(22) Filed: Nov. 20, 2015

(30) Foreign Application Priority Data
Jun. 3, 2015 (KR) 10-2015-0078636

(51) Int. Cl. F21V 8/00

(52) U.S. Cl. CPC G02B 6/0023; G02B 6/0091; G02B 6/0026; G02B 6/0065; G02B 6/0073

(57) ABSTRACT

According to an exemplary embodiment, the output end may be reduced in thickness when compared to that of the output end in accordance with the related art. Therefore, the output end may be applied to the light guide plate having the thin thickness, and also, the display device including the backlight unit having the thin thickness may be manufactured. In addition, the light emitting device package may not be limited to the thickness thereof, unlike the light emitting device package in accordance with the related art.

### CROSS-REFERENCE TO RELATED APPLICATION

This application claims priority to Korean Patent Application No. 10-2015-0078636 filed on Jun. 3, 2015 and all the benefits accruing therefrom under 35 U.S.C. §119, the contents of which are incorporated by reference in their entirety.

### BACKGROUND

The present disclosure relates to a light source unit and a method for manufacturing the same, and more particularly, a light source unit provided with a thin light output end and a method for manufacturing the same.

A backlight module to which a side view-type light source unit is applied includes a light guide plate disposed above a substrate (hereinafter, referred to as a module substrate) in parallel with the module substrate and a light source unit disposed to be spaced apart from a side surface of the light guide plate at the side surface of the light guide plate. The light source unit includes a device substrate and a plurality of light emitting device package spaced apart from each other on the device substrate to generate light and output the generated light to the light guide plate.

Each of the light emitting device packages includes a light emitting chip generating light, a housing having an inner space, i.e., a cavity and molded on the device substrate so that the light emitting chip is disposed in the cavity, and an output unit molded to fill the cavity provided in the housing to allow the light emitted from the light emitting chip to be emitted toward the side surface of the light guide plate. Also, each of the light emitting device packages includes first and second lead frames disposed on the device substrate and a wire electrically connecting the first and second lead frames to the light emitting chip. Here, the light emitting chip may be a light emitting diode (LED) chip.

The cavity of the housing may have a radial shape having an inner diameter that gradually increases from an area, on which the light emitting chip is disposed, in a direction in which the light is emitted to the light guide plate. The output unit in which a phosphor and resin are mixed may be disposed in the cavity.

A thickness of the light guide plate that will be described below denotes a height or length in a vertical direction of the light guide plate. Also, a thickness or width of each of the light source unit and the output unit denotes a height or length in the vertical direction in a state where an output end of the output unit faces the side surface of the light guide plate.

As a display device having a thin thickness is required, it may be necessary to recue a thickness of the backlight module. For this, the light guide plate has to have a thin thickness, and also, the thickness of the light source unit, i.e., the thickness of the output end through light is outputted to the light guide plate has to be reduced so that the light is smoothly supplied to the light guide plate. To reduce the thickness of the light guide plate, the light emitting device package has to be reduced in thickness. Thus, a mounting end and the output end of the output unit may be reduced in thickness. Also, since the output unit has a width that gradually decreases from the mounting end to the output end, the more the light source unit decreases in thickness, the more the mounting end increases in width reduction effect. Thus, the light emitting chip having a size that is reduced by the reduced width of the mounting end has to be mounted. However, since the reduction in size of the light emitting chip is technically limited, it may be limited to reduce the width of the mounting end, i.e., the thickness of the light emitting device package.

Thus, the light guide plate may be manufactured to a thickness of approximately 300 μm or more. However, it may be difficult to manufacture the light emitting device package including the output end having the thickness approximately 300 μm or more. Although the light emitting device package including the output end having a thickness of more than approximately 300 μm is applied to the light guide plate having the thickness of approximately 300 μm or more, light may be emitted to the outside of the light guide plate because the output end has a thickness greater than that A of the light guide plate.

### PRIOR ART DOCUMENTS

### Patent Documents

Korean Patent Publication No. 2009-0102952

### SUMMARY

The present disclosure provides a light source unit including a thin light output end and a method for manufacturing the same.

The present disclosure also provides a light source unit that is capable of being applied to a light guide plate having a thin thickness and a method for manufacturing the same.

In accordance with an exemplary embodiment, a side-view type light source unit configured to provide light in a direction of a side surface of a light guide plate includes: a light emitting chip spaced to face the side surface of the light guide plate, thereby generating light; an output unit extending from the light emitting chip toward the side surface of the light guide plate to cover the light emitting chip, the output unit including a mounting end on which the light emitting chip is disposed and an output end that is an end extending from the mounting end and outputs the light generated from the light emitting chip to the side surface of the light guide plate; and a housing disposed to cover the output end while exposing the output end of the output unit, the housing being configured to shield emission of the light of the output unit in different directions except for a direction of the output end, wherein the output end of the output unit has a thickness less than that of the mounting end.

The output unit may have a thickness that gradually decreases from the mounting end to the output end.

A width in a direction crossing a thickness direction of the output end of the output unit may be less than that of the mounting end.

The output unit may have a width that gradually decreases from the mounting end to the output end in the direction crossing the thickness direction thereof.

The output end may have a thickness of approximately 300 μm or less.

The output unit may include a transparent resin and a phosphor.

In accordance with another exemplary embodiment, a method for manufacturing a side-view type light source unit configured to provide light in a direction of a side surface of a light guide plate includes: forming at least a light emitting device package on a device substrate, wherein the forming of the light emitting device package includes: bonding a light emitting chip to the device substrate; performing a primarily molding process by using a first material including a transparent resin and a phosphor to cover the light emitting chip, thereby forming an output unit extending from the light emitting chip in one direction so that an output end disposed to face a mounting end and output light generated from the light emitting chip has a thickness less than that of the mounting end on which the light emitting chip is disposed; and performing a secondary molding process on the output unit by using a second material having a light shielding function to form a housing covering the output unit so that the housing covers different areas except for the output end.

In the forming of the output unit, the output unit may have a thickness that gradually decreases from the mounting end to the output end.

In the forming of the output unit, a width in a direction crossing a thickness direction of the output end of the output unit may be less than that of the mounting end.

In the forming of the output unit, the output unit may have a width that gradually decreases from the mounting end to the output end in the direction crossing the thickness direction thereof.

The output end may have a thickness of approximately 300 μm or less.

The device substrate may include a printed circuit board (PCB), and before the bonding of the light emitting chip to the device substrate, the method may further include: forming a lead frame on the device substrate; applying die bonding epoxy on the lead frame, wherein the bonding of the light emitting chip to the device substrate may include a wire bonding process of bonding the light emitting chip to the die bonding epoxy to electrically connect the lead frame to the light emitting chip.

After the lead frame and the light emitting chip are electrically connected to each other, the primarily molding process may be performed to form the output unit so that the output unit covers the light emitting chip, and after the output unit is formed, the secondary molding process may be performed to form the housing.

The plurality of light emitting device packages may be formed to be spaced apart from each other on the device substrate, and the method may further include cutting the output units of the plurality of light emitting device packages along a spaced space between the output units.

### BRIEF DESCRIPTION OF THE DRAWINGS

Exemplary embodiments can be understood in more detail from the following description taken in conjunction with the accompanying drawings, in which:

FIG. 1 is a top surface of a backlight module including a plurality of side-view type light source units;

FIG. 2 is a front view of a backlight module including a light emitting device package of a backlight module in accordance with a related art;

FIG. 3 is a front view of a light emitting device package of the backlight module in accordance with the related art;

FIG. 4 is a schematic front view of a backlight module including a side-view type light source unit in accordance with an exemplary embodiment when viewed from a lateral side.

FIG. 5 is a three-dimensional view of the side-view type light source unit in accordance with an exemplary embodiment;

FIG. 6 is a three-dimensional view of the side-view type light source unit in accordance with another exemplary embodiment.

FIG. 7 is a front view of the light source unit in accordance with an exemplary embodiment; and

FIGS. 8A-8E are cross-sectional views illustrating a method for manufacturing the side-view type light source unit in accordance with an exemplary embodiment.

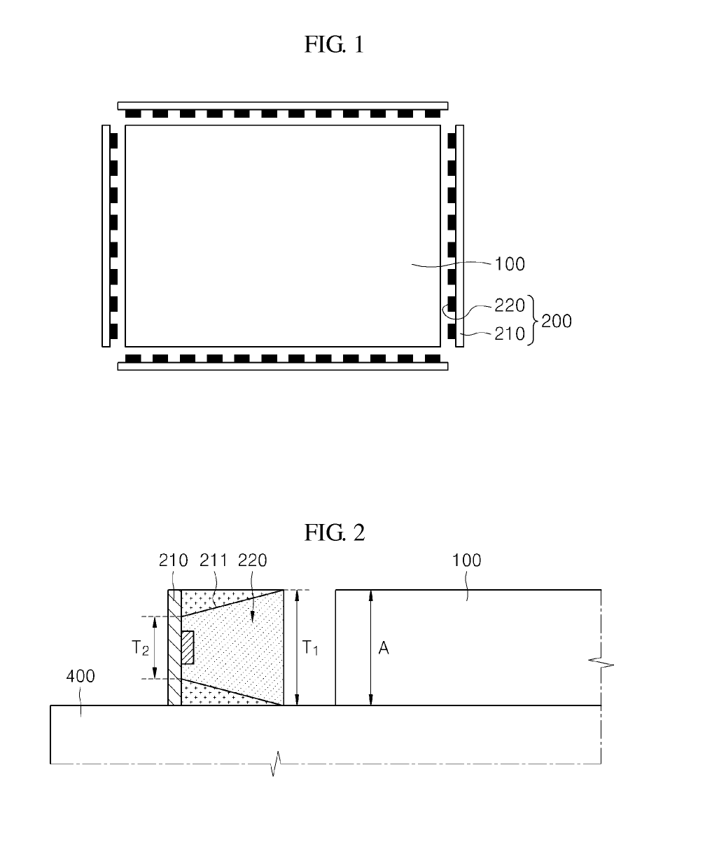

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that the present invention will be thorough and complete, and will fully convey the scope of the present invention to those skilled in the art.

The present disclosure relates to a light source unit for providing light to a light guide plate, and more particularly, to a side-view type light source unit that is disposed in a lateral direction of the light guide plate. Provided are a side-view type light source unit including a light output end having a thin thickness so that the light guide plate having a thin thickness is easily applied and a method for manufacturing the same in accordance with an exemplary embodiment.

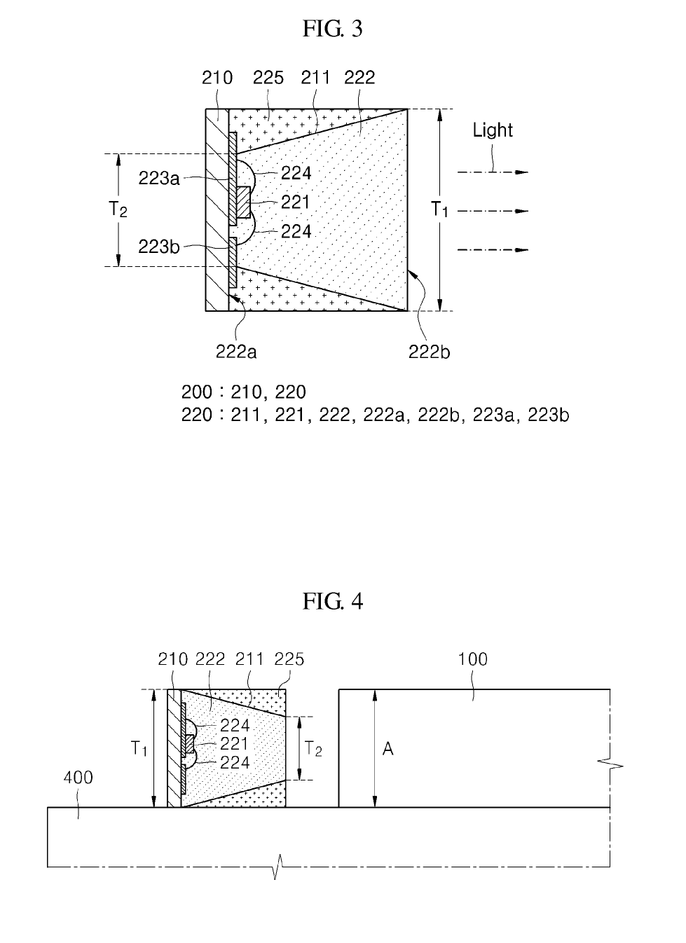

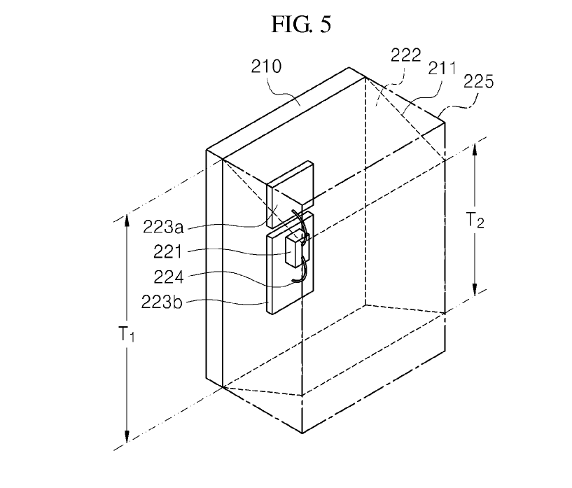

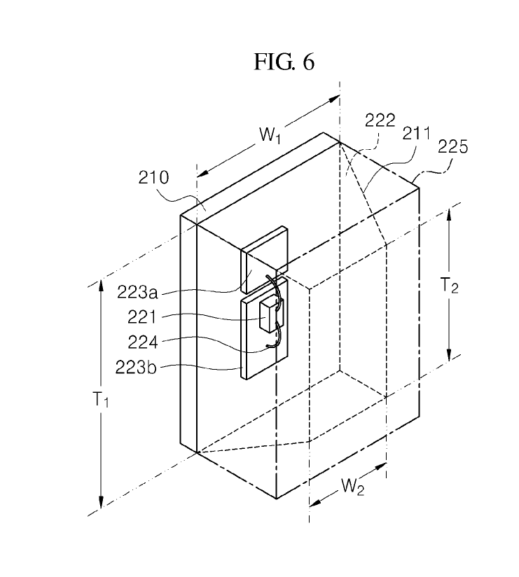

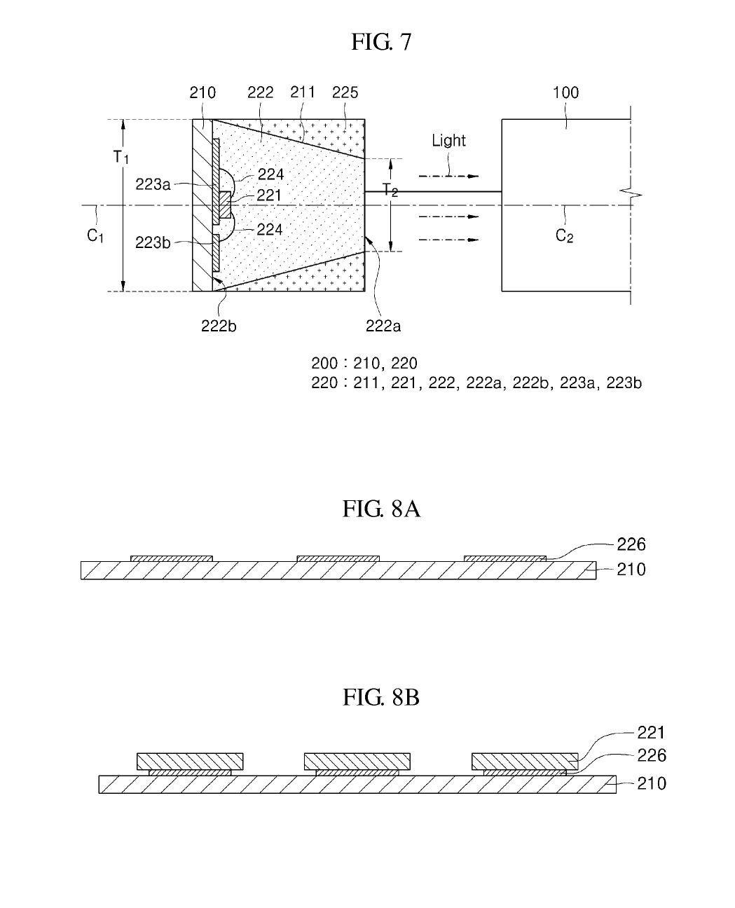

FIG. 4 is a schematic front view of a backlight module including a side-view type light source unit in accordance with an exemplary embodiment when viewed from a lateral side. FIG. 5 is a three-dimensional view of the side-view type light source unit in accordance with an exemplary embodiment. FIG. 6 is a three-dimensional view of the side-view type light source unit in accordance with another exemplary embodiment. FIG. 7 is a front view of the light source unit in accordance with an exemplary embodiment.

Referring to FIG. 4, a backlight module in accordance with an exemplary embodiment includes a module substrate 400, a light guide plate 100 disposed on the module substrate 400 to supply light to a display panel, and a light source unit 200 disposed to be spaced apart from the light guide plate 100 in a lateral direction to provide light to the light guide plate 100. The module substrate 400 may be a printed circuit board (PCB). The light guide plate 100 may have a rectangular shape in cross-section. The light source unit 200 is provided in four, and the four light source units 200 are disposed to correspond to four side surfaces of the light guide plate 100.

Since the PCB used as the module substrate 400 and the light guide plate 100 are well known to be used for the display device, their descriptions will be omitted.

The light source unit 200 includes a device substrate 210 and at least a light emitting device package 200 disposed on the device substrate 210 to generate light. The light source unit 200 in accordance with an exemplary embodiment includes a plurality of light emitting device packages 220 arranged on the device substrate 210 in directions corresponding to the side surfaces of the light guide plate 100.

A thickness A of the light guide plate 100, which will be described later, denotes a vertical height or length of the light guide plate 100. Also, a thickness or width of each of the light source unit 200 and the light emitting part 222 denotes a vertical height or length in a state where an output end of the light emitting part 222 faces the side surface of the light guide plate 100.

Since the plurality of light emitting device packages 220 have the same constituents, one light emitting device package 220 will be described as an example.

Referring to FIGS. 4 to 7, the light emitting device package 220 in accordance with an exemplary embodiment includes a light emitting chip 220 mounted on the device substrate 210 to generate light, an output unit 220 extending from the light emitting chip 221 in one direction to cover the light emitting chip 221, having a vertical length or thickness that gradually decreases from a direction in which the light emitting chip 221 is disposed toward the extending direction of the light emitting chip 221, and emitting the light generated from the light emitting chip 221 to one side surface of the light guide plate 100, and a housing 225 covering the output unit 222 while exposing a surface thereof facing the light guide plate 100. The light emitting chip in accordance with an exemplary embodiment may be a light emitting diode (LED). Also, the light emitting device package 220 includes first and second lead frames 223a and 223b disposed to be spaced apart from each other on the device substrate 210 and a wire 224 electrically connecting the first and second lead frames 223a and 223b to the light emitting chip 221.

The output unit 220 may output the light generated from the light emitting chip 221 toward the side surface of the light guide plate 100. The output unit 222 may cover the light emitting device package 220 so that the light emitting device package 220 is disposed therein. That is to say, the output unit 222 extends from the position of the device substrate 210 in one direction to cover the light emitting device package 220. In the output unit 222, the device substrate 210, the first and second lead frames 223a and 223b, and the light emitting chip 221 are mounted on one end of the output unit 221 in the extending direction of the output unit 222, and the light generated from the light emitting chip 221 is exposed from the other end of the output unit 222 to the outside side. The output unit 222 is formed of a light transmitting resin or a plurality of phosphors that are dispersed in a resin. The resin may be at least one of silicon and epoxy resins, but is not limited thereto. For example, other resins having light transmitting properties and high heat resistance may be applicable.

Hereinafter, for convenience in description, an end of both ends of the output unit 222, on which the device substrate 210, the first and second lead frames 223a and 223b, and the light emitting chip 221 are disposed or in contact therewith is called a mounting end 222a, and the other end facing the mounting end 222a, I.e., an end through which the light generated from the light emitting chip 221 is emitted to the outside is called an output end 222b.

Explaining again the output unit 222 in accordance with an exemplary embodiment by using the above-described definitions, the output end 222b of the output unit 222 has a thickness T2 less than that T1 of the mounting end 222a on which the light emitting chip 221 is mounted. In detail, the output unit 222 may have a trapezoid shape having a thickness that gradually decreases from the mounting end 222a to the output end 222b. In other words, the output unit 222 may have a trapezoid shape having a thickness that gradually increases from the output end 222b in the direction in which the mounting end 222a is disposed. Here, the output end 222b of the output unit 222 may have a thickness T2 of approximately 300 μm or less, more preferably, approximately 100 μm. Also, the output unit 220 of FIG. 5 in accordance with an exemplary embodiment may have a uniform length or width W in a horizontal direction from the mounting end 222a to the output end 222b. However, the present disclosure is not limited thereto. As described in another embodiment with reference to FIG. 6, the output unit 220 may have a trapezoid shape having a horizontal length, i.e., width that gradually decreases from the mounting end to the output end. In other words, the mounting end may have a width W1 less than that W2 of the output end W2. Thus, the output unit in accordance with another embodiment may have the trapezoid shape having the thicknesses T1 and T2 that gradually decrease from the mounting end to the output end and widths W1 and W2 that gradually decrease from the mounting end to the output end.

Since the output unit 222 has the shape having the thickness that gradually decreases from the mounting end 222a to the output end 222b in accordance with the exemplary embodiments, the output end 222b may be reduced in thickness when compared to that of the output unit in accordance with the related art. Thus, the output unit may be easily applied to the light guide plate 100 having the thin thickness, and also, the display device including the backlight unit having the thin thickness may be manufactured.

Also, since the output unit 222 has the thickness that gradually decreases from the mounting end 222a to the output end 222b as described above, the light emitting device package 222 may be not limited to thickness thereof when compared to the light emitting device package in accordance with the related art.

As the display device having the thin thickness is required, it may be necessary to recue a thickness of the backlight module. For this, the light guide plate 100 has to have the thin thickness A, and also, the thickness of the light source unit, i.e., the thickness of the output end through light is outputted to the light guide plate 100 has to be reduced so that the light is smoothly supplied to the light guide plate 100.

However, in the light emitting device package 220 in accordance with the related art, as illustrated in FIGS. 2 and 3, each of the cavity 211 or output unit 222 of the housing 225 has a trapezoid shape having a thickness that gradually increases from an area (hereinafter, referred to an mounting end 222a), on which the light emitting chip 221 is disposed or mounted, to an output end 222b through which light is emitted to the light guide plate 100. That is, in the cavity 211 or output unit 222 of the housing 225, the output end 222b may have a thickness T2 greater than that of the mounting end 222a. In other words, the mounting end has a thickness T2 less than that of the output end 222b.

Since the output unit 222 has the vertical length or thickness that gradually increases from the mounting end 222a to the output end 222b, the more the light source unit 200 decreases in thickness, the more the mounting end 222a increases in reduction effect of the vertical length T1. Thus, the light emitting chip 221 having a size that is reduced by the reduced vertical length T1 or width T1 of the mounting end 222a has to be mounted.

However, since the reduction in size of the light emitting chip 221 is technically limited, it may be limited to reduce the vertical width T1 of the mounting end 222a, i.e., the thickness of the light emitting device package 220.

However, since the output unit 222 has the thickness that gradually increases from the output end 222b to the mounting end 222a in accordance with an exemplary embodiment as illustrated in FIGS. 4 to 7, the light emitting device package 222 may be not limited to thickness thereof when compared to the light emitting device package in accordance with the related art. Thus, the light emitting device package 220 having the thin thickness, on which the light emitting chip 221 having a general size is capable of being easily mounted, may be manufactured without manufacturing the light emitting chip having low light emitting efficiency and a size that is difficult to be manufactured.

In addition, when the light source unit in accordance with an exemplary embodiment is installed, the light source unit may be installed so that a vertical center C1 of the light emitting device package matches a vertical center C2 of the light guide plate 100. In other words, the light source unit may be installed so that a vertical center C1 of the output end 222b matches the vertical center C2 of the light guide plate 100.

The housing 225 is disposed to cover the outside of the output unit 222. Thus, the housing 225 may cover other areas except for the output end 222b of the output unit 222 to prevent light from being emitted in directions except for the direction in which the output end 222b is disposed. That is, the housing 225 may be disposed to cover an outer surface of the output unit 222 except for the output end 222b while exposing the output end 222b of at least the output unit 222. The housing 225 is formed of a material that is capable of shielding light. In an exemplary embodiment, the housing 225 may be formed of an epoxy mold compound (EMC) that is a thermosetting resin. However, the present disclosure is not limited thereto. For example, the housing 225 may be formed of various materials that are capable of shielding light, e.g., one of silicon (Si), aluminum (Al), aluminum nitride (AlN), sapphire (Al₂O₃), and ceramic.

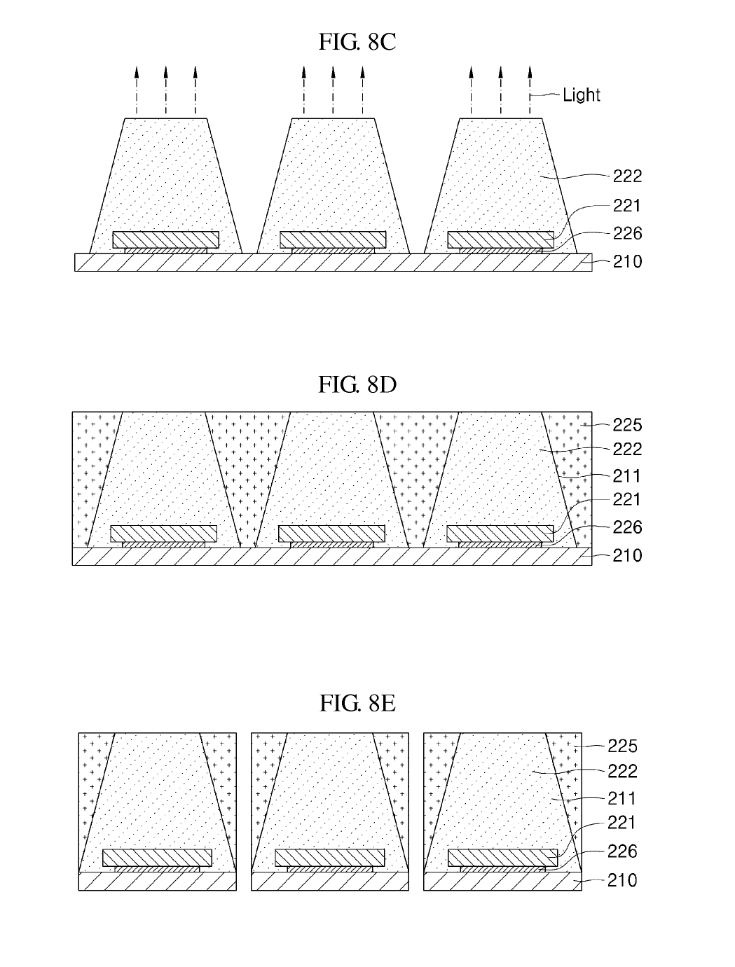

FIG. 8 is a view of a method for manufacturing the side-view type light source unit in accordance with an exemplary embodiment.

A method for manufacturing the side-view type light source unit in accordance with an exemplary embodiment will be described with reference to FIG. 8. Here, a manufacturing method including a process of forming a plurality of light emitting device packages on a device substrate and a process of cutting the device substrate.

First, a device substrate 210 having a predetermined area, e.g., a PCB is prepared, and first and second lead frames (not shown) are formed on the device substrate 210. Also, as illustrated in FIG. 8A, die epoxy 226 is applied to the first and second lead frames (not shown). Then, a chip bonding process for mounting light emitting chips 221 on the die bonding epoxy 226 applied to the device substrate 210 is performed (see FIG. 8B).

As illustrated as FIG. 8C, an output unit 222 is formed on the device substrate 210 to cover each of the plurality of light emitting chips 221. For this, a first material in which a light transmitting resin and a phosphor are mixed with each other is prepared. Also, a first molding process for molding the first material to cover each of the light emitting chips 221 is performed to form a plurality of output units 222 that are spaced apart from each other.

For this, a mold is prepared on a side of an upper portion of each of the device substrate 210 and the plurality of output units 222, and the first material is injected into an empty space provided in the mold and then is molded and cured. Here, the output unit 222 is manufactured in a trapezoid shape having a thickness that gradually decreases from an area, on which the device substrate 210 or the light emitting chip 221 is disposed, in an extending direction of the device substrate 210 or the light emitting chip 221. In other words, the output unit 222 may have a trapezoid shape having a thickness that gradually increases from the output end 222a, on which the device substrate 210 and the light emitting chip 221 are disposed or in contact therewith, to the output end 222b through which light is emitted to the outside. Thus, in the output unit 222, the output end 222b may have a vertical length T2 or thickness T2 less than that of the mounting end 222a on which the light emitting chip 221 is mounted. In other words, the mounting end 222a of the output unit 222 may have a vertical length T1 or thickness T1 less than that of the output end 222b.

Next, as illustrated in FIG. 8D, a housing 255 is formed to cover the outside of the output unit 222 except for the output end 222b while exposing the output end 222b of each of the plurality of output units 222. That is, a second material having a light shielding function, for example, an EMC resin is prepared. A secondary molding process for molding the EMC resin on the output unit 222 is performed to form the housing.

Also, as illustrated in FIG. 8E, the output units formed to be spaced apart from each other may be cut and separated from each other to manufacture the light device packages as illustrated in FIG. 5.

As described above, when the output unit 222 is manufactured, the output unit may have a thickness that gradually decreases from the output end 222a to the output end 222b. Thus, the output end 222b may be reduced in thickness when compared to that of the output terminal in accordance with the related art, and thus may be easily applied to the light guide plate 100 having the thin thickness. Therefore, the display device including the backlight module having the thin thickness may be manufactured. Also, since the output unit 222 has the thickness that gradually increases from the output end 222b to the mounting end 222a in accordance with the exemplary embodiments, the light emitting device package having the thinner thickness than that of the light emitting device package in accordance to the related art and capable of being effectively applied to the light guide plate having the thin thickness may be manufactured.

Thus, the light emitting device package 220 having the thin thickness, on which the light emitting chip 221 having the general size and the high light emitting efficiency is capable of being easily mounted, may be manufactured without manufacturing the light emitting chip having low light emitting efficiency and a size that is difficult to be manufactured.

In accordance with the exemplary embodiments, the output unit is manufactured so that a thickness thereof decreases from the mounting end toward the output end. Thus, the output end may be reduced in thickness when compared to that of the output end in accordance with the related art, and thus may be easily applied to the light guide plate having the thin thickness. Therefore, the display device including the backlight module having the thin thickness may be manufactured. Also, in accordance with the exemplary embodiments, since the output end is manufactured so that a thickness thereof increases from the output end toward the mounting end. Thus, the light emitting device package may not be limited to the thickness thereof, unlike the light emitting device package in accordance with the related art. Thus, the light emitting device package having the thin thickness, on which the light emitting chip having the general size and the high light emitting efficiency is capable of being easily mounted, may be manufactured without manufacturing the light emitting chip having low light emitting efficiency and a size that is difficult to be manufactured.

Although the light source unit and the method for manufacturing the same have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A side-view type light source unit configured to provide light in a direction of a side surface of a light guide plate, the light source unit comprising:
a light emitting chip spaced to face the side surface of the light guide plate, thereby generating light;
an output unit extending from the light emitting chip toward the side surface of the light guide plate to cover the light emitting chip, the output unit comprising a mounting end on which the light emitting chip is disposed and an output end that is an end extending from the mounting end and outputs the light generated from the light emitting chip to the side surface of the light guide plate; and
a housing disposed to cover the output end while exposing the output end of the output unit, the housing being configured to shield emission of the light of the output unit in different directions except for a direction of the output end,
wherein the output end of the output unit has a thickness less than that of the mounting end.

2. The light source unit of claim 1, wherein the output unit has a thickness that gradually decreases from the mounting end to the output end.

3. The light source unit of claim 2, wherein a width in a direction crossing a thickness direction of the output end of the output unit is less than that of the mounting end.

4. The light source unit of claim 3, wherein the output unit has a width that gradually decreases from the mounting end to the output end in the direction crossing the thickness direction thereof.

5. The light source unit of claim 4, wherein the output end has a thickness of approximately 300 μm or less.

6. The light source unit of claim 1, wherein the output unit comprises a transparent resin and a phosphor.

7. A method for manufacturing a side-view type light source unit configured to provide light in a direction of a side surface of a light guide plate, the method comprising:
forming at least a light emitting device package on a device substrate,
wherein the forming of the light emitting device package comprises:
bonding a light emitting chip to the device substrate;
performing a primarily molding process by using a first material comprising a transparent resin and a phosphor to cover the light emitting chip, thereby forming an output unit extending from the light emitting chip in one direction so that an output end disposed to face a mounting end and output light generated from the light emitting chip has a thickness less than that of the mounting end on which the light emitting chip is disposed; and
performing a secondary molding process on the output unit by using a second material having a light shielding function to form a housing covering the output unit so that the housing covers different areas except for the output end.

8. The method of claim 7, wherein, in the forming of the output unit, the output unit has a thickness that gradually decreases from the mounting end to the output end.

9. The method of claim 8, wherein, in the forming of the output unit, a width in a direction crossing a thickness direction of the output end of the output unit is less than that of the mounting end.

10. The method of claim 9, wherein, in the forming of the output unit, the output unit has a width that gradually decreases from the mounting end to the output end in the direction crossing the thickness direction thereof.

11. The method of claim 10, wherein the output end has a thickness of approximately 300 μm or less.

12. The method of claim 11, wherein the device substrate comprises a printed circuit board (PCB), and
before the bonding of the light emitting chip to the device substrate, the method further comprises:
forming a lead frame on the device substrate;
applying die bonding epoxy on the lead frame,
wherein the bonding of the light emitting chip to the device substrate comprises a wire bonding process of bonding the light emitting chip to the die bonding epoxy to electrically connect the lead frame to the light emitting chip.

13. The method of claim 12, wherein, after the lead frame and the light emitting chip are electrically connected to each other, the primarily molding process is performed to form the output unit so that the output unit covers the light emitting chip, and after the output unit is formed, the secondary molding process is performed to form the housing.

14. The method of claim 7, wherein the plurality of light emitting device packages are formed to be spaced apart from each other on the device substrate, and the method further comprises cutting the output units of the plurality of light emitting device packages along a spaced space between the output units.
